(19) United States
(12) Patent Application Publication
(10) Pub. No.: US 2021/0211815 A1
(43) Pub. Date: Jul. 8, 2021

(54) METHOD FOR CHARGING AN ELECTRICAL DEVICE WORN IN THE EAR CANAL, ELECTRICAL DEVICE, CHARGING MODULE, AND HEARING SYSTEM

(71) Applicant: Vibrosonic GmbH, Mannheim (DE)

(72) Inventors: Tobias Fritzsche, Ludwigshafen (DE); Dominik Kaltenbacher, Mannheim (DE); Jonathan Schächtele, Mannheim (DE); Florian Strobl, Heddesheim (DE); Martin Theuring, Mannheim (DE)

(21) Appl. No.: 17/250,068

(22) PCT Filed: May 20, 2019
(86) PCT No.: PCT/EP2019/062985

§ 371 Date: Nov. 18, 2020

(30) Foreign Application Priority Data
May 18, 2018 (DE) 10 2018 207 918.8

(51) Int. Cl. H04R 25/00; H02J 7/00; H02J 7/02; H04R 1/10

(52) U.S. Cl. CPC H04R 25/602; H02J 7/0042; H02J 7/02; H04R 25/554; H04R 1/1025; H04R 2225/57; H04R 2225/023; H04R 2225/025; H04R 2225/31; H04R 2225/55; H04R 25/556

(57) ABSTRACT

The invention relates to a method for charging an electrical device worn in the ear canal, wherein the electrical device is arranged in the ear of a person and a charging module for transmitting electrical energy is connected to the electrical device arranged in the ear. The invention also relates to an electrical device with which such a method may be carried out, a charging module with which such a method may be carried out, and a hearing system with which such a method may be carried out. The electrical device may advantageously be a hearing device or also a hearable or a Smart headphone.

The invention relates to a method for charging an electrical device worn in the ear canal, wherein the electrical device is arranged in the ear of a person and a charging module for transmitting electrical energy is connected to the electrical device arranged in the ear. The invention also relates to an electrical device with which such a method may be carried out, a charging module with which such a method may be carried out, and a hearing system with which such a method may be carried out. The electrical device may advantageously be a hearing device or also a hearable or a Smart headphone.

There are a number of reasons to insert a hearing device as deeply as possible into the outer ear canal (CIC: completely in the canal). The reasons for this may be aesthetic, since such a hearing aid is hardly visible from the outside, which is desired by many users. A sound pickup deep in the ear canal also leads to a natural perception of sound. Reasons related to the operating mode may also play a role. In some systems the positioning is provided in such a way that it cannot be performed by the user himself, but only by trained staff (for example an ENT doctor). A problem with this category of hearing devices is their power supply.

The object of the invention is to provide a method for charging an electrical device worn in the ear canal, by means of which method the electrical device may be charged without having to be removed from the ear canal. A further object is to describe a corresponding electrical device, a corresponding charging module, and a corresponding hearing system.

The object is achieved by the method according to claim 1, the electrical device according to claim 9, the charging module according to claim 13, and the hearing system according to claim 26. The dependent claims describe advantageous refinements of the method according to the invention, of the electrical device according to the invention, of the charging module according to the invention, and of the hearing system according to the invention.

In accordance with the invention, a method for charging an electrical device is described. The electrical device has a rechargeable accumulator and/or a rechargeable battery. The accumulator or the battery preferably has such a capacity that the hearing device, once the accumulator or the battery has been fully charged, is operable at least for 12 hours, particularly preferably 24 hours, without further charging.

The electrical device is preferably a device which delivers sound signals to the eardrum of the person wearing it. It may advantageously be a hearing device which serves as a hearing aid, or also a hearable or a Smart headphone. All electrical devices of this kind worn in the ear canal will be referred to synonymously hereinafter as hearing devices.

In accordance with the invention, the electrical device is arranged in a person's ear as it is being charged. The electrical device is thus charged whilst it is being worn by the person. For charging, a charging module is connected to the electrical device arranged in the ear for transmitting electrical energy from the charging module to the electrical device. A connection between the charging module and the electrical device arranged in the ear is thus produced, via which electrical energy is transmittable from the charging module to the electrical device. The accumulator or the battery of the electrical device is then charged by transmission of electrical energy from the charging module to the electrical device.

In an advantageous embodiment of the invention, the electrical device is arranged in the person's ear canal such that a distal end of the electrical device is arranged proximally of, or at most 5 mm, preferably at most 2 mm distally of a distal end of the ear canal. The terms “proximally” and “distally” are used here in the conventional sense as direction indicators, with distally meaning the direction facing away from the center of the person's body and proximally meaning the direction facing the center of the person's body.

In this embodiment, the electrical device is thus arranged for the most part or substantially completely in the interior of the person's ear canal; it may thus be a hearing device which is not removed from the user. The method according to the invention is particularly advantageous here because it allows temporally unlimited use of such a device, regardless of the capacity of the battery.

The method according to the invention is advantageous if the device is arranged completely in the interior of the ear canal, that is to say proximally of the distal end of the ear canal. In particular, the distance of the distal end of the device from the distal end of the ear canal is greater than or equal to 2 mm, preferably greater than or equal to 4 mm, particularly preferably greater than or equal to 6 mm. In this case, the device is therefore a device that is arranged in the ear canal in a manner not removable by the user or only removable with the use of tools.

The distal end of the device is understood here to mean the end of the device or the side of the device that is arranged furthest distally when the device is used correctly.

In an advantageous embodiment of the invention, the electrical energy may be transmitted wirelessly from the charging module to the electrical device. The charging module and the electrical device may thus form a wireless transmission path for electrical power. The power transmission or energy transmission may then be achieved inductively, capacitively and/or optically. It is possible to use only one of the transmission possibilities or also to combine a plurality of these transmission paths with one another.

It is also advantageously possible to transmit the energy via at least one wire from the charging module to the electrical device. In this case, the charging module and/or the electrical device may have connection points for the wire which preferably are detachable and reusable.

An embodiment of the invention in which a wired connection is combined with wireless energy transmission is particularly advantageous. In this embodiment of the invention, a wire may be arranged on the charging module, which wire is electrically connected to the charging module. At the end of the wire furthest from the charging module, there may be arranged a transmission device for wireless energy transmission, for example a light source, a coil or a condenser plate. A corresponding receiving device for wireless energy transmission may then be arranged on the electrical device, for example a photodiode or another device for converting light energy into electrical energy, a coil or a condenser plate, corresponding to the aforementioned transmission device.

In an advantageous embodiment of the invention, it is possible that, during the charging, there is also a signal transmission from the charging module to the hearing device and/or from the hearing device to the charging module. The hearing device and/or the charging module, to this end, may have suitable inputs and/or outputs for the signal transmission. Here, the signal may be, in particular, an audio signal and/or an information or data signal. By means of this embodiment, it is possible that, if the charging module hinders the path of sound to the hearing device, the charging module absorbs the sound and forwards it in the form of an audio signal to the hearing device. The charging module may then also be coupled to an external audio source, for example an MP3 player. In this way, an audio signal of the electrical device, for example of the MP3 player or of a mobile telephone, may be forwarded via the charging module to the hearing device. If the signal transmission comprises a data transmission, settings may thus also be transmitted to the hearing device. On the other hand, a signal transmission from the hearing device to the charging module makes it possible to transmit information, for example regarding a state of the hearing device, to the charging module so that said information may be read there. For example, information regarding the state of charge of the battery or of the accumulator of the hearing device may thus be transmitted to the charging module and may be read there.

If the method according to the invention includes both a wireless energy transmission and a wireless signal transmission, the energy and signal may thus be transmitted over the same channel. Advantageously, however, the energy and the signal may also be transmitted between the charging module and the hearing device over different channels. A channel is understood here generally to mean a transmission path (for example optical, inductive, capacitive, etc.).

In an advantageous embodiment, an input of the electrical device into which the electrical energy is introduced from the charging module may have an impedance that is changeable by the electrical device. The change may advantageously code a piece of information. The charging module may then advantageously measure the impedance and reconstruct the information on this basis. The information may be, for example, a state of charge of the energy store.

The method according to the invention is applicable particularly advantageously for electrical devices that remain in the ear canal for longer than a week, preferably for longer than a month, and/or that are implanted. Such devices are normally not removable by the user or are only removable by the use of tools, so that, according to the prior art, a visit to the doctor is required once the charge of the accumulator or the battery is depleted. The method according to the invention, by contrast, makes it possible, even in such cases, to wear the device for a long period of time, without the need to visit a specialist in order to recharge the device.

The electrical device, in accordance with the invention, has a rechargeable store for electrical energy, that is to say for example an accumulator or a rechargeable battery. So that the hearing device is chargeable via the charging module, said device may have at least one input for electrical energy. The store for electrical energy may then be chargeable via this input. To this end, the input may be electrically contacted with the store.

The electrical device is preferably shaped such that it is arrangeable in the ear canal of the person so that a distal end of the device lies proximally or 5 mm, preferably at most 2 mm distally of a distal end of the ear canal. This feature signifies an indirect limitation of the outer shape of the electrical device to shapes that are arrangeable in the ear canal of a person. The device may be tailored individually to a person. In this case, the dimensions would be specified individually on the basis of the dimensions of the ear canal of this person. However, the device may also be designed for series manufacture. In this case, its shape is preferably matched to the average dimensions of ear canals of adult individuals. If a mass-produced electrical device of this kind were to be provided for children, its dimensions could thus be matched to the average dimensions of ear canals of children from the corresponding age group.

The electrical device is preferably dimensioned in such a way that it is arrangeable proximally of the distal end of the ear canal of the person and then particularly preferably has a distance of the distal end of the hearing device from the distal end of the ear canal of greater than or equal to 2 mm, preferably greater than or equal to 4 mm, particularly preferably greater than or equal to 6 mm.

The electrical device, if it is to be arranged in the ear canal, may advantageously have anchoring means on its outer side, by means of which it may be held against the inner wall of the ear canal. Such anchoring means may be, for example, bristles, flaps, wings, rings, spirals or differently shaped structures on the outer side of the electrical device, which extend from the surface of the electrical device to the wall of the ear canal and support the electrical device there. The anchoring means preferably have a certain mechanical flexibility, so that the anchoring means, when inserted in the intended position, adapt to the shape of the ear canal. This is achievable, for example, in that the anchoring means are formed from a resilient material, such as silicone, polyurethane foam or a comparable material. If the electrical device is contacted by a wire by means of mechanical contact, for example a plug, a force with which the anchoring means hold the electrical device in the ear canal is thus preferably greater than a force that is necessary to establish and/or release mechanical connection. In this way, the mechanical contact may be established and/or released without moving the electrical device.

In an advantageous embodiment, the hearing device may be an eardrum contact hearing device. The method according to the invention is particularly advantageous for hearing devices of this kind, since normally they are not removable by the user, and therefore recharging is advantageous in order to avoid visits to the doctor.

The input for electrical energy of the electrical devices advantageously a plug contact or an input for wireless energy transmission. If, for example, the energy is thus transmitted from the charging module to the device inductively, the input thus may comprise or may be a coil. If the energy is transmitted from the charging module to the device capacitively, the input thus may comprise or may be an electrically conductive surface. If the energy for charging is transmitted optically, the input thus may comprise or may be a photodiode, for example.

A method as described above preferably may be carried out with the electrical device according to the invention.

In accordance with the invention, a charging module for charging electrical device in the ear of a person is additionally described. The charging model is thus designed so that it may be used to charge an electrical device in the ear of a person. In this case, the charging module has an output for electrical energy which is connectable to an input for electrical energy of the electrical device for the purpose of transmitting electrical energy. If the electrical energy is transmitted inductively for example, the output thus may comprise or may be a coil. If the electrical energy is transmitted capacitively, the output thus may comprise or may be an electrically conductive surface, for example. If the energy is transmitted optically, the output thus may comprise or may be a light source, for example.

In accordance with the invention, the charging module may be introduced fully or partially into the ear canal the person or is shaped so that it may rest on an auricle or part of an auricle of the person wearing the electrical device or may clasp around an auricle of the person wearing the electrical device. In this way, the charging module may be arranged at a sufficiently short distance from the electrical device arranged in the ear canal, so that the energy transmission is made possible. If the energy is transmitted optically as described, at least the output for electrical energy thus may be placed in position in a manner oriented relative to the electrical device so that there is a line of sight between the output of the charging module and the input for electrical energy.

The charging module may be tailored individually to the person using the electrical device. In this case, the dimensions of the charging module are selected so that the described possibilities for arrangement are feasible. This dimensioning is then based on the specific dimensions of the ear of the person wearing the electrical device. However, it is also advantageously possible to produce the charging module on a mass scale. In this case, the dimensions for achieving the corresponding possibilities for arrangement are based on the average dimensions of ears or ear canals of adult individuals. If the charging module is intended for use by children, its dimensions may thus be based on the average dimensions of the ears of children from the corresponding age group.

The charging device is preferably suitable for wearing on the head. To this end, it may have, for example, a flexible structure and/or at least one curved band, at the end of which there is arranged at least part of the charging module. In this way, the charging module part of the charging module may be shaped similarly to a headset.

It is also advantageously possible to shape the charging module similarly to an earphone. To this end, for example, it may have a portion that is so small that it is arrangeable directly at the exit of the ear canal, preferably so as to close the ear canal. It may optionally have a part that, when covering the ear canal, protrudes beyond the auricle and, for example, is used to hold the charging module on the ear. For example, the charging module may have a curved ear clip, which is shaped so that it is arrangeable between an auricle and a head of the person, partially running around the auricle. Part of the charging module which is arrangeable directly in front of the exit of the ear canal or in a manner engaging in the ear canal may then be arranged on the clip.

In an advantageous embodiment of the invention, the charging module may be designed so that it may rest on an auricle or so that it may rest against a head and at the same time may surround an auricle. In the first case, the charging device may be shaped similarly to on-ear headphones, and in the latter case the charging device may be similar to closed headphones, for example over-ear headphones.

In a further advantageous embodiment of the invention, the charging module may have an ear unit, which in turn has an auricle part, which has a diameter greater than a diameter of the ear canal and smaller than a diameter of the auricle. In addition, the ear unit may have at least one ear canal part, which has a diameter smaller than or equal to the diameter of the ear canal. Here, the output for electrical energy is particularly preferably arranged on the ear canal part such that, when used correctly, it is arranged in the ear canal.

The charging module may advantageously have an accumulator and/or a battery, by means of which the energy for charging the hearing device may be provided. Such a battery may comprise or may consist of one or more nickel-metal hydride cells, for example. Such a battery may also comprise or may consist of one or more lithium ion cells. In addition, the battery may also comprise or consist of one or more silver-zinc cells.

The battery of the charging device may advantageously be chargeable via wireless energy transmission.

The charging module may advantageously also have at least one contact, for example a USB port or the like, by means of which energy for charging the hearing device may be supplied. If the charging device has a battery, this battery may thus also be charged by means of such a contact. In an advantageous embodiment, by means of such a contact, both the battery of the charging module may be charged, and also energy for charging the electrical device arranged in the ear canal may be provided, particularly preferably at the same time. The charging module may be designed so that, whilst it is being worn, it may be supplied with energy via contacts. This energy supplied via the contacts may then be used to charge the battery of the charging device and also to provide the power that is used to charge the electrical device arranged in the ear canal and is transmitted to the electrical device, as described above. By means of an input for electrical energy, it may thus be possible to supply electrical energy to a store (provided as necessary) for electrical energy of the charging module and/or the output for electrical energy. The input for electrical energy transmission may be an input for wireless energy transmission or for wired energy transmission.

A (possibly provided) battery of the charging module also might not be rechargeable, and in this case may then be exchangeable. Such a battery may be, for example, a cell according to the IEC and/or ANSI standard.

Advantageously, the electrical energy may be conducted from the energy store of the charging module to the output for electrical energy of the charging module. To this end, an electrical connection may be established as appropriate between the store for electrical energy of the charging module and the output.

The charging module may additionally be designed advantageously so that it may receive signals from external devices and may forward said signals to the electrical device arranged in the ear canal. For example, the charging device may in this way be coupled via audio and/or data interfaces to external devices, for example Smartphones, and/or to configuration devices. In this case, the communication with the external devices may advantageously be wireless. The communication with the electrical device arranged in the ear canal may also be wireless.

In an advantageous embodiment of the invention, the charging module may have one or more microphones, by means of which sound from a surrounding environment is receivable during the charging process. The charging module may generate a signal on this basis, which signal is transmittable to the hearing device, as described above. In this way, the hearing device may still be used as a hearing aid during the charging process.

If a person is wearing a hearing device on both ears, it is therefore advantageous if the charging module has two separate parts, with said parts being provided one for each ear. That stated above applies similarly for each of the parts. It is also possible that the charging module in this way has two parts, although only one of the parts is used, for example in the case of monoaural supply.

In an advantageous embodiment, the two parts of the charging module may exchange data with one another via a wireless or wired interface. The data transmission between the parts may be performed inductively, for example via an NFMI or via radio. By means of such an interface for data transmission, it is possible to synchronize a state of the parts of the charging module at both ears. In this way, for example, setting profiles on both sides may be brought into conformity with one another. Binaural hearing device functions may also be utilized in this way, for example noise suppression, localization and/or focusing, etc.

In an advantageous embodiment of the invention, one or both parts of the charging module may be designed as earplugs, which may be placed in the auricle. If only one part is provided, the charging module may thus be in earplug of this kind.

In an advantageous embodiment of the invention, the charging module may additionally have one or more housings, additionally to the parts arranged on the ears. For example, one or more batteries, electronic components and/or operating elements may be accommodated in said housing(s).

If the charging module has two parts, these may both have their own battery. However, it is also possible that the two parts are connected to a common housing part. This may in turn have processing electronics and/or a battery.

If the charging module has two ear parts, these may be connected to one another via a flexible structure, for example at least one bendable curved band or a cable.

It is advantageously possible to accommodate at least one battery, electronic components and/or operating elements and/or display elements in such a flexible structure itself, that is to say for example in the cable or in the curved band itself.

The charging module according to the invention is advantageously designed so that a method for charging an electrical device arranged in the ear canal as described above may be carried out with the charging module.

In accordance with the invention, a hearing system is also described, which on the one hand has at least one electrical device as described above, that is to say for example a hearing device, and on the other hand has at least one charging module as described above. In this case, the charging module has an output for electrical energy which is connectable to an input for electrical energy of the electrical device arranged in the ear canal for the purpose of transmitting electrical energy. In the event that the electrical device is a hearing device, the hearing system may also be referred to as a hearing device system.

The hearing system may advantageously have two of the hearing devices and/or two of the charging modules, preferably one for each of a person's ears.

In the described hearing system, the two parts of the charging module may advantageously be connected via a communications device for transmitting data between the parts of the charging module. The communications device may advantageously transmit data inductively or via radio waves.

The charging modules or the parts of the charging module are advantageously switchable on and off separately from one another for different ears.

A method as described above may be carried out advantageously with a hearing system of this kind.

The invention will be explained hereinafter by way of example with reference to a number of figures. Like reference signs denote like or corresponding features. The features described in the examples may also be realized independently of the corresponding example and may be combined between different examples.

In the drawings

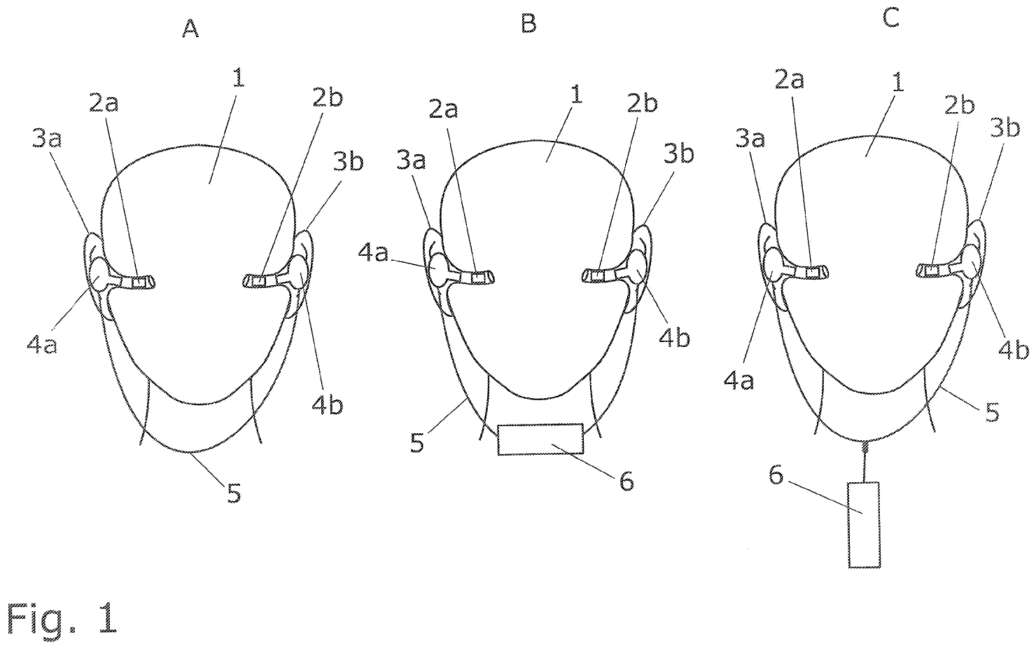

FIG. 1 shows various embodiments of the charging module with two parts arranged on the head of a person,

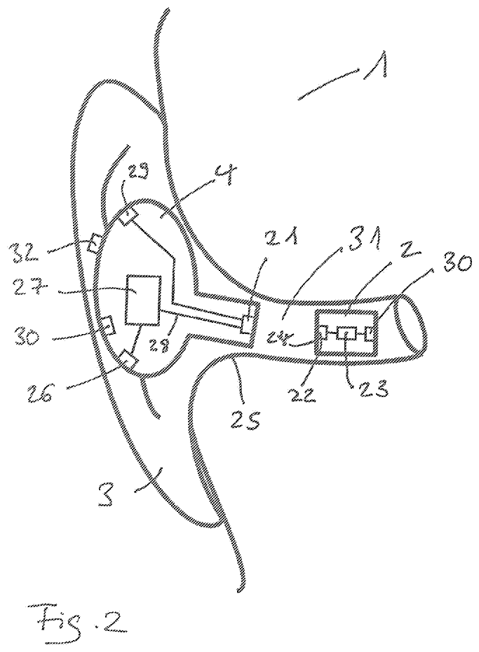

FIG. 2 shows a schematic illustration of a hearing system corresponding to the present invention, by means of which a method according to the invention for charging an electrical device worn in the ear may be carried out,

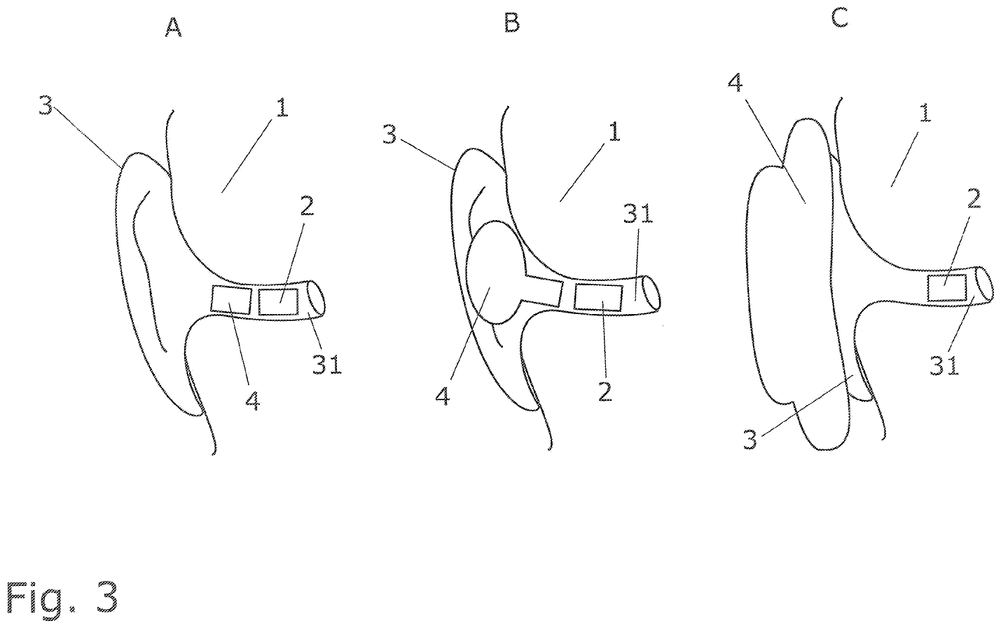

FIG. 3 shows various housing forms of a charging module,

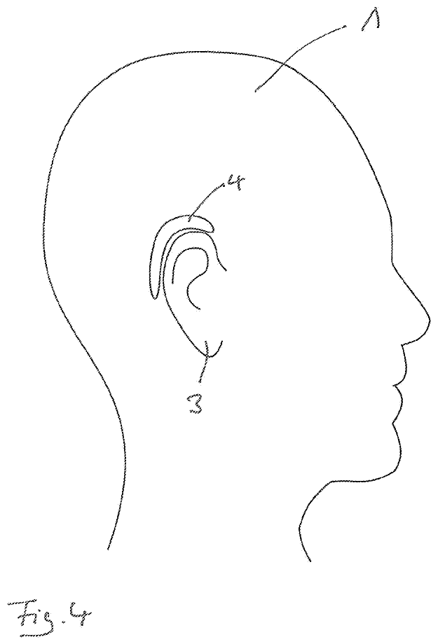

FIG. 4 shows an embodiment of the charging module in the form of a clip,

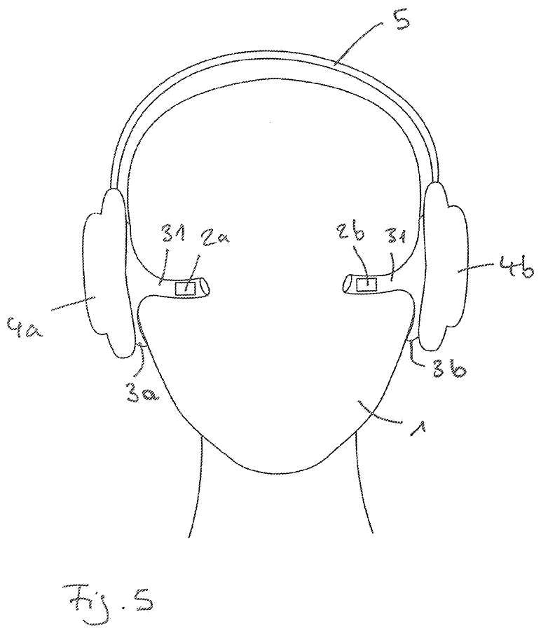

FIG. 5 shows a hearing system according to the invention with charging module in the form of headphones,

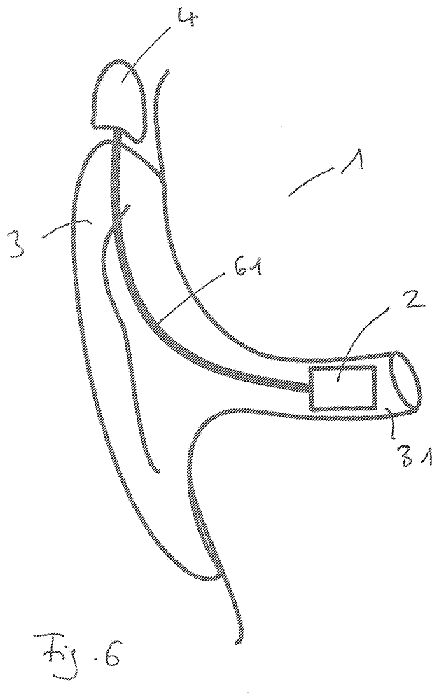

FIG. 6 shows a contacting, via a cable, of a charging module in clip form with an electrical device worn in the ear,

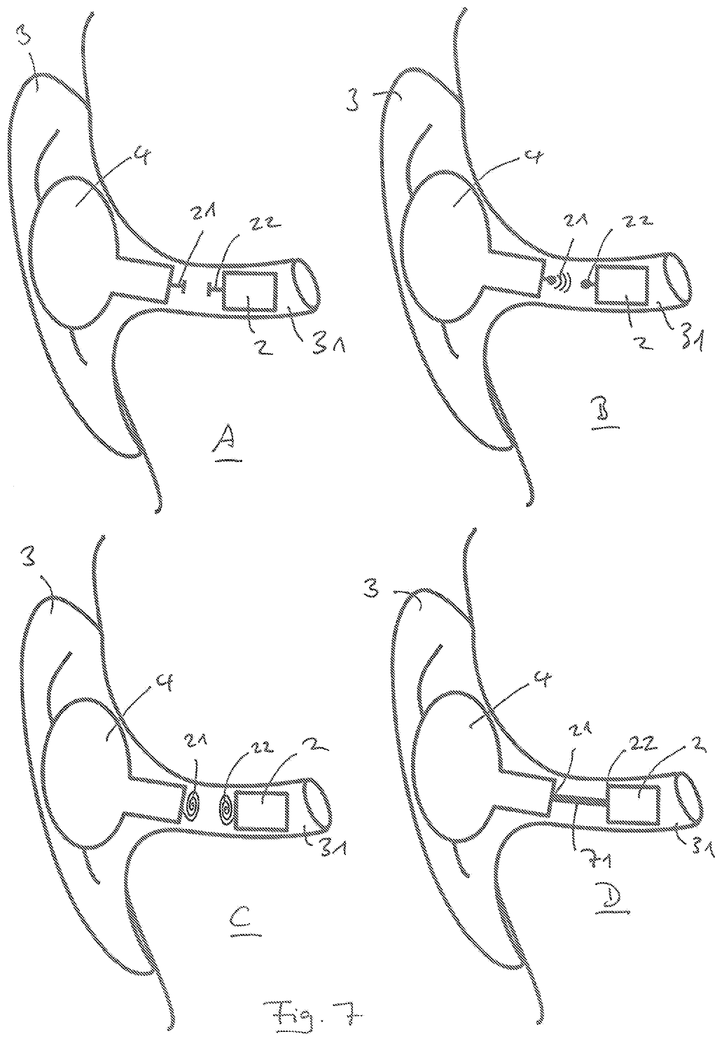

FIG. 7 shows various possibilities of energy transmission and/or signal transmission,

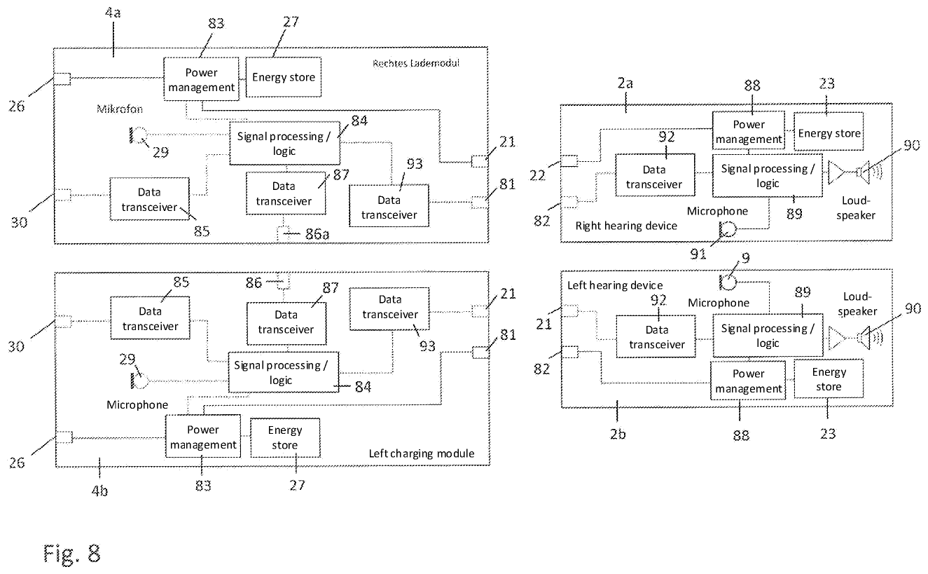

FIG. 8 shows a schematic circuit diagram of a hearing system with separate charging modules for the left and right ear, and

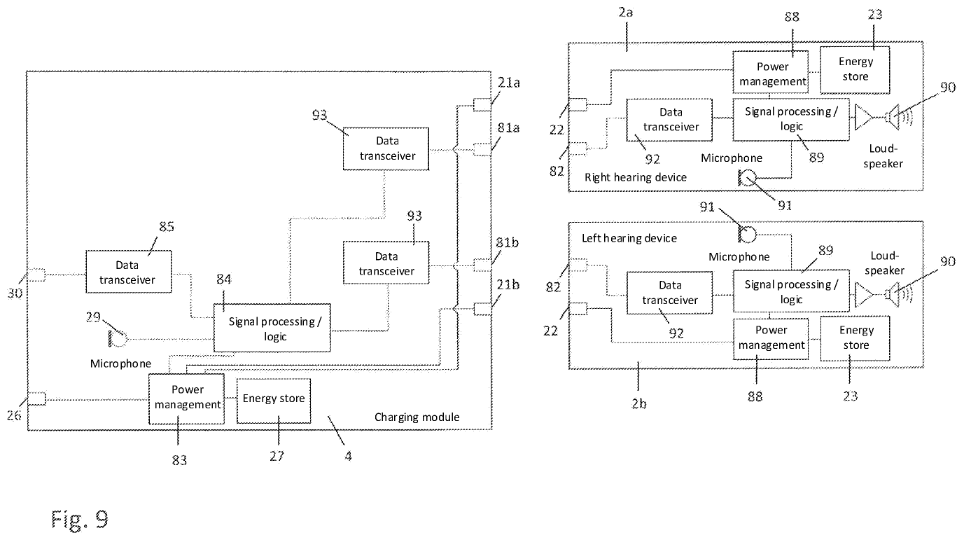

FIG. 9 shows a hearing system with common charging module for the left and right ear.

FIG. 1, in sub-figures A, B and C, shows different embodiments of a hearing system according to the invention by means of which a method according to the invention for charging a hearing device 2a, 2b may be carried out. The hearing system in each case has two hearing devices 2a, and 2b, which are arranged in the ears 3a, 3b of a person 1, deep in the ear canal. The hearing system additionally has two charging modules 4a and 4b or two parts 4a, 4b of a charging module 4, which are arranged one in each of the auricles of the ears 3a, 3b. In the example shown in FIG. 1, the parts 4a, 4b are designed so that they each have a part that penetrates into the ear canal and a part that has a diameter greater than the ear canal and in which the auricle of the ear 3a or 3b is arranged.

In FIG. 1A, the two parts 4a and 4b of the charging module are connected to one another via a curved band 5 or cable 5 and are arranged at the ends of said band or cable. The curved band 5 or the cable 5 holds the parts 4a and 4b and may also allow an energy and/or data transmission between the charging module parts 4a and 4b.

FIG. 1B shows an embodiment that differs from the embodiment shown in FIG. 1A in that a further housing 6 is arranged in the curved band 5 or cable 5, in which housing it is possible for components to be accommodated that support the function of the charging module parts 4a and 4b. For example, stores for electrical energy, such as batteries or accumulators, processing electronics, operating elements and/or processing electronics may be arranged in the housing 6.

In FIG. 1B the housing 6 is arranged between two halves of the curved band 5 or cable 5 and connects these two halves.

FIG. 1C shows a further embodiment of the hearing system according to the invention which differs from the embodiment shown in FIG. 1B in that the housing 6 is not arranged between two halves of the curved band 5 or cable 5, but instead is connected to the curved band 5 or cable 5 by a separate connection. The two halves of the curved band 5 or cable 5 in this case therefore are directly adjacent to one another, and the housing 6 is connected to the curved band by means of a further line. As in FIG. 1B, the housing 6 may have electrical components and/or energy stores such as accumulators or batteries, which are used to support the charging module parts 4a and 4b.

FIG. 2 schematically shows a charging module 4, which is arranged in the ear 3 of a person 1 and together with a hearing device 2, which is arranged in the ear canal 31 of the person 1, forms a hearing system. The charging module 4 has an output 21 for electrical energy, from which electrical energy is transmittable to an input 22 of the hearing device 2. The input 22 for electrical energy of the hearing device 2 is connected to an energy store 23 of the hearing device which is charged by the transmitted electrical energy.

The hearing device 2 sits in the ear canal 31 of the person 1 so that its distal end 24 lies proximally of a distal end 25 of the ear canal.

The charging module 4 has an input 26 for electrical energy, by means of which electrical energy may be supplied in order to charge an accumulator 27 in the charging module 4. The accumulator 27 is connected via a line 28 to the output 21 for electrical energy. In this way, the accumulator 27 may store electrical energy by means of which the hearing device 2 is chargeable.

It is also optionally possible to establish a direct connection between the input 26 for electrical energy and the output 21 for electrical energy of the charging module 4.

In the example shown in FIG. 2, the charging module 4 additionally has a microphone 29, by means of which ambient noise is receivable. The signal generated by the microphone 29 may be transmitted to the output 21 for electrical energy and may be transmitted via said output to the hearing device 2. During this process, such signals may also undergo a processing, for example by a converter unit and/or a signal processor. In this way, the hearing device 2 may forward the signal received by the microphone 29 to the user, so that the user is still able to hear whilst the charging module 4 is arranged in his ear.

The charging module 4 may additionally have a communications interface 30, by means of which a communications connection to external devices may be established. By means of such an interface 30, communication with devices such as Smartphones, Smartwatches, computers/notebooks, televisions, hands-free devices in a car and/or additional microphones may be established, for example. In this way, the hearing device may be used, for example, also as a hands-free device for making telephone calls or as headphones for listening to music or watching films. Externally coupled microphones may also be coupled in this way to the hearing device and may be placed close to a sound source of interest, for example a conversation partner. The interface 30 may also be arranged directly on the hearing device 2. If the interface is arranged on the charging module 4, the signals received from the interface 30 may be transmitted to the hearing device 2 via the output 21 or a separate output. An arrangement of the interface 30 on the hearing device 2 itself allows a direct coupling of the hearing device 2 to the described external devices. Such an interface 30 may be, for example, a near-field communications interface, such as Bluetooth, or an inductive interface, such as NFMI.

An arrangement of the interface 30 on the charging module 4 reduces the energy consumption in the hearing device 2 and therefore, in some circumstances, also the creation of heat in the hearing device 2. The battery service life is also increased. An arrangement of the interface 30 in the hearing device 2 itself, however, provides the described functions also independently of the charging device 4.

The signal transmission and the energy transmission from the charging module 4 to the hearing device 2 may be established simultaneously. In an advantageous embodiment of the invention, a sampling rate of a digital signal processor may be increased, whereby the bandwidth of the sound output by the hearing device 2 is increased. Such a mode may be activated, for example, when wearing the charging module. A higher power demand of the hearing device during the signal transmission from and/or to the charging module and/or the use of a mode with increased sampling rate may thus be compensated. The store for electrical energy 23 of the hearing device may also be charged at the same time.

In order to carry out the method according to the invention, the charging module 4 is introduced into the ear 3 or the ear canal 31 in such a way that an energy transmission from the charging module 4 to the hearing device 2 is possible. The transmission in this case may be wired or wireless. The wireless transmission, for example, may be capacitive, inductive or optical or a combination thereof.

A wired transmission may be provided, for example, via at least two compatible plug contacts, spring contacts, exposed electrical contacts, etc. or a combination thereof. These are designed so that, as the charging module 4 is introduced into the ear canal 31, they establish an electrical connection between the charging module 4 and the hearing device 2 and thus allow an energy transmission between the components; the contacts may advantageously comprise or consist of a corrosion-resistant metal, for example gold, platinum, iridium or alloys thereof.

In the case of an inductive energy transmission, the charging module 4 and the hearing device 2 each have at least one coil, and the charging module 4 generates a magnetic alternating field in the coil with the aid of a suitable circuit, which magnetic alternating field induces an alternating voltage in the one or more coils of the hearing device 2. This alternating voltage may be rectified in the hearing device 2 with the aid of a suitable rectifier circuit. The rectified signal may then be filtered by means of low-pass filtering. In this way, the accumulator 23 of the hearing device 2 may be charged via the induced voltage.

In the case of a capacitive energy transmission between charging module 4 and hearing device 2, both components may have at least one electrically conductive surface (capacitor) each, which, for a charging process, advantageously both may be positioned as congruently as possible and as closely to one another as possible but electrically insulated from one another. In the charging module 4, an alternating voltage is generated with the aid of a suitable electrical circuit and is applied there to the capacitor. The voltage generated on account of the resultant electrical field in the capacitor of the hearing device 2, in a possible embodiment of the invention, may be rectified with the aid of a suitable electrical circuit and may be used, after a possible electric (low-pass) filtering, to charge the store 23 in the hearing device 2.

An optical energy transmission between the charging module 4 and the hearing device 2 is also possible. To this end, the charging module 4 may have a light source, such as an LED or a laser diode. The emission spectrum thereof may preferably lie in the range of from 350 nm to 2,000 nm, preferably in the range between 550 nm and 1,000 nm. The light source is advantageously arranged in the charging module in such a way that, with or without the use of suitable optical elements, such as lenses, the optical radiation of the light source may be directed as fully as possible onto an optical receiving element, such as a photodiode or solar cell, of the hearing device 2, and generates a voltage there, which may be used to charge the accumulator 23 in the hearing device 2. An optical emission power of the light source may be temporally constant or also may vary over time.

In order to allow further functions when the charging module 4 is being worn, in an advantageous embodiment of the invention the hearing system may have an interface for signal transmission between the charging module and the hearing device. This may be wired or wireless, for example inductive, capacitive and/or optical, for example similarly to the energy transmission. Radio methods in different frequency ranges, for example from 100 kHz to 100 GHz, preferably 10 MHz to 10 GHz, may be used. Standardized methods, such as Bluetooth (LE), NFC, etc. may advantageously be used.

In an advantageous embodiment of the invention, the hearing device 2 may have components, such as a microphone for receiving sound, an amplifier circuit, a sound converter for acoustic forwarding of electrical signals to the eardrum and/or a rechargeable store 23 for electrical energy. In an advantageous embodiment of the invention, the hearing device 2 may additionally have one or more of the following components: A digital signal processing chain, preferably with associated AD and DA converter units, at least one processor unit for processing a communication signal which is received from the charging module 4 or is transmitted to the charging module 4, an energy receiving unit for energy transmission, an accumulator charging electronics unit and/or a monitoring electronics unit.

Forms of the charging module 4, in particular housing forms of the charging module 4, may advantageously be based on designs of headphones and/or earphones.

FIG. 3 shows possible housing forms of the charging module 4. In FIG. 3A the charging module 4 is arranged fully in the ear canal 31. The housing is dimensioned here such that it may be inserted fully into the ear canal 31. The form thus corresponds substantially to an ear canal receiver.

FIG. 3B shows an embodiment in which the charging module 4 has a portion that is larger than a diameter of the ear canal 31, but smaller than a diameter of the auricle 3. In addition, the charging module 4 in FIG. 3B has a further part, which has a diameter smaller than or equal to the diameter of the ear canal 31. Such a charging module 4 may be arranged in the ear canal 31 with the ear canal part, the diameter of which is sufficiently small. The form corresponds for example to an earbud earphone.

FIG. 3C shows an embodiment of the charging module 4, wherein the charging module 4 has dimensions such that the charging module 4 fully surrounds the auricle 3. The form thus corresponds to headphones. The charging module 4 is worn here on the head and thus has at least one ear part, which comes to lie in, against or over the auricle 3. Such charging modules 4 may be worn in public without attracting much attention, and thus make it possible to integrate the charging of the hearing device(s) 2 into everyday life.

The charging module 4 may advantageously have its own charging energy source or may be directly connected to same, for example integrated into one or more further components. In this way, one-time or repeated full charging of the accumulator 23 of the hearing device 2 may be made possible. The shape of the charging module 4 may also be designed so as to achieve the best-possible wearing comfort. To this end, those parts of the charging module that come into contact with the ear 3 or the head with correct use may also comprise otoplastics, foam and/or silicone pads and the like.

Whilst the charging module 4 is arranged on the ear 3, the sound power of the hearing device 2 may be reduced, since the sound path to the hearing device 2 is obstructed. The charging module 4 itself may therefore advantageously have a possibility for sound conversion. For example, the charging module 4 may be equipped with one or more microphones and may have its own signal processor unit. The received, processed sound signals may then be transmitted by means of the above-described signal transmission interface to the hearing device 2, and may be reproduced there for the user using a sound converter unit. If hearing devices 2a, 2b are provided one in the left ear and one in the right ear, the charging module parts 4a, 4b may thus be connected to one another by means of a cable or a radio interface, directly or via a further external unit. In this way, binaural hearing device functions may be made possible.

The hearing system according to the invention may have two charging module parts 4a, 4b, specifically for the right ear and the left ear. These may be connected to a cable whilst the system is being worn and charged, but do not have to be. The two charging modules may additionally be connected to a charging component 6, in which further elements may be arranged, for example a charging energy source, an energy transmission system, control electronics, and further auxiliary components. The corresponding elements may also be arranged in the charging module 4 or charging module parts 4a, 4b itself, and may be built therein redundantly.

In accordance with the invention it is advantageously possible that the two charging module parts 4a, 4b are connected to one another. In this way, the necessary components, such as charging energy source, energy transmission system, control electronics, and further auxiliary components, may be distributed over both charging module parts and only have to be provided once on the whole.

If the two charging module parts, or, with just one-sided use of a hearing aid, only one charging module, are additionally connected to one or more external charging components 6 and/or, with a two-sided hearing aid, to one another, the components possibly provided, such as charging energy source, energy transmission system, control electronics and possibly auxiliary components, may thus be provided at least in part only once and may be distributed over the different components. The charging energy source may advantageously allow one-time or repeated full charging of the hearing device(s) 2a, 2b or of the accumulator 23. The charging energy source advantageously has a greater, preferably much greater capacity than the energy store 23 in the hearing device.

As described, it is also possible to provide the charging energy source by way of non-rechargeable energy stores, for example zinc-air batteries. These may be accommodated, for example, in one or more charging components 6 or in one or both charging module parts 4a, 4b. They may be replaced by the user of the hearing device 2 as necessary.

In an advantageous embodiment of the invention, the charging energy source may be provided by a rechargeable energy store, for example a lithium ion accumulator. This may be arranged in one or more charging components 6, or may be arranged in one (with two-sided use) or both storage module parts 4a, 4b and may be charged by the user of the hearing device as necessary. Such a charging may be achieved, for example, with one or more wired (for example USB port) or wireless interfaces (for example Qi, AirFuel, etc.).

In accordance with the invention, a charging component 6 may be provided, which is connected to the charging module(s) 4. In an advantageous embodiment, the charging component 6 may be connected by means of a cable to the charging modules or charging module parts 4a, 4b, as is shown in FIG. 1. In the variant shown in FIG. 1B, the two cables coming from the charging module parts 4a, 4b are amalgamated with one cable and are connected in this way to the charging component 6. In a further possible embodiment, the charging component 6 may be connected by means of just one cable 5 to one of possibly two worn charging module parts 4a, 4b, as is shown in FIG. 1C. In this case, with use of a two-sided hearing aid, the two charging module parts 4a, 4b may be connected to one another additionally by means of one cable 5.

In order to operate specific functions of the charging component 6, of the charging module 4, and of the hearing aid 2, operating elements 32 may be provided on the charging component 6 or the charging modules 4, as shown in FIG. 2. These may be used, for example, to change the volume of the hearing device playback, to switch the hearing device 2 on and off, or to operate further functions.

In order to display specific parameters, device states (such as state of charge of the charging energy source 27 or of the accumulator 23 of the hearing device, volume, etc.), the charging component 6 and/or the charging module 4, in an advantageous embodiment, may have one or more display elements, such as displays or single- or multi-colored LEDs, etc.

In a preferred embodiment of the invention, a communications interface to external devices may be constructed with the charging module 4 and/or the hearing device 2 or also with a charging component 6. External devices may be, for example, Smartphones, Smartwatches, computers/notebooks, televisions, hands-free devices in a car, or additional microphones, etc. Users of hearing devices 2 may, in this way, use their hearing device 2 also as a hands-free device for making telephone calls or as headphones when listening to music or watching films. In surroundings with a lot of ambient noise, externally coupled microphones which may be placed close to the sound source of interest, for example the conversation partner, may also be advantageous.

Near-field communication interfaces, such as Bluetooth, or inductive interfaces, such as NFMI, may be used for the coupling of such external sources and sinks. A direct connection of such interfaces to the hearing device 2 has the advantage that they may be used independently of the charging module 4. A connection of such interfaces to the charging module 4 has the advantage that the battery 23 of the hearing device 2 is loaded to a lesser extent, thus extending the service life. In addition, the electromagnetic waves of the signal are damped or absorbed to a lesser extent by the body tissue, since the charging module 4 or the charging module 4 in combination with the charging component 6 is worn further outside the body as compared to the hearing device 2. The charging module 4, optionally also in combination with a charging component 6, may thus be used as communication relay during the application of said external devices. In this case, the charging module 4 or the charging module 4 in combination with the charging component 6 may establish the communication connection to the external devices.

FIG. 4 shows a charging module 4 which is arranged on the head 1 of a person and which in the shown example has the form of a clip. The charging module 4 in the form of a clip is arranged here between the head 1 and the auricle 3 of the person 1. The charging module 4 in this case runs partially around the region where the auricle 3 is adjacent to the head 1. In this way, the charging module 4 may be held by the ear 3.

FIG. 5 shows a hearing system according to the invention with two hearing devices 2a and 2b and also two parts 4a and 4b of a charging module, wherein the parts 4a and 4b are connected to one another via a curved band 5 and are held by this curved band on the ears 3 of the person 1. The charging modules 4a and 4b are auricle-shaped and surround the ears 3a, 3b fully.

FIG. 6 shows a front view of a charging module 4 in the form of a clip similar to that shown in FIG. 4. In the example shown in FIG. 6, the charging module 4 is connected to the electrical device 2 in the ear canal 31 via a cable 61.

FIG. 7 shows various possibilities for establishing electrical contact for energy transmission and/or signal contact between a charging module 4 or a part of a charging module 4 and an electrical device 2 arranged in the ear canal 31. The charging module 4 and the electrical device 2 are arranged in the ear canal 31 as shown in FIG. 2. In the example shown in FIG. 7A, the energy transmission and/or signal transmission is capacitive. To this end, the charging module 4 has an electrically conductive surface as output 21 for electrical energy and/or as output 21 for a signal. Correspondingly, the charging module 2 has an electrically conductive surface as input 22 for electrical energy and/or as input 22 for a signal.

In the example shown in FIG. 7B, the energy transmission and/or signal transmission is performed via electromagnetic waves, for example radio or light. To this end, the charging module 4 has a transmitter 21 for electromagnetic waves as electrical output and/or as signal output 21, and the electrical device 2 has a receiver 22 for the electromagnetic waves.

FIG. 7C shows an example in which the energy transmission and/or the data or signal transmission is inductive. To this end, the charging module 4 has a coil as output for electrical energy 21 and/or as output for the signal connection 21. Correspondingly, the electrical device 2 in the ear canal 31 has a coil as input 24 for the electrical energy and/or as input 24 for the signal.

In the example shown in FIG. 7D, the transmission of the energy and/or signals between the charging module 4 and the electrical device 2 in the ear canal 31 is achieved via a cable 71. The cable 71 may be coupled from the side of the charging module 4 to the output 21 for electrical energy and/or to the output for signals and from the side of the electrical device 2 to the input 22 for electrical energy and/or for the signal.

FIG. 8 shows schematically a circuit diagram of a hearing system having two electrical devices 2a, 2b and also two parts 4a and 4b of a charging module 4. The part 4a of the charging module is coupled to the device 2a, here a hearing device 2a, via a connection for the transmission of electrical energy, wherein the charging module part 4a has an output 21 for electrical energy, via which electrical energy is transmittable to an input 22 for electrical energy of the hearing device 2a. In the shown example, the charging module part 4a additionally has an output 81 for data or signals which is connected to an input 82 for data or signals of the device 2a. By way of example, the principles shown in FIG. 7 may be used both for the data transmission and for the energy transmission.

Correspondingly, the charging module part 4b and the hearing device 2b also have inputs and outputs for transmission of electrical energy and of data signals.

The charging module parts 4a, 4b each have an input 26 for electrical energy, via which energy may be supplied from outside to the corresponding charging module part 4a, 4b.

The charging module parts 4a, 4b additionally each have an input 30 for supplying data signals. External signal sources or data sources may be coupled via this input to the charging modules 4a, 4b.

The charging module parts 4a, 4b each have energy management parts 83, which are coupled to the inputs 26 for electrical energy and which may supply the electrical energy on the one hand to an energy store 27 and on the other hand may supply the energy directly to the corresponding output 21 for electrical energy. The energy management unit 83 is coupled to the signal processing unit 84 and may be controlled thereby.

The data interfaces 30 are coupled in the shown example via data transceivers 85 to the signal processing unit 84.

The charging module parts 4a and 4b in the shown example additionally have communications interfaces 86a and 86b, via which the charging module parts 4a and 4b may exchange signals with one another. These interfaces are each coupled via a data transceiver 87 to the corresponding signal processing unit 84.

The hearing devices 2a, 2b each have an energy management unit 88, via which electrical energy supplied through the inputs 22 for electrical energy may be distributed over the corresponding energy store 23 and a signal processing unit 89.

The inputs for data signals 82 are coupled in the shown example via data transceivers 92 to the signal processing unit 89.

The hearing devices 2a, 2b in the shown example additionally each have a microphone 91, which is in turn coupled to the corresponding signal processing unit 89. The signal processing unit 89 is, for its part, connected to a loudspeaker 90, via which sound signals may be output to the eardrum of the person.

FIG. 9 shows a further example of a hearing system according to the invention. In this case, the system has two hearing devices 2a and 2b, which are designed as shown in FIG. 8. With regard to the hearing devices 2a and 2b, reference should therefore be made to the description of FIG. 8. The hearing system shown in FIG. 9 additionally has a charging module 4, which in this case is a common charging module 4 for both hearing devices 2a and 2b.

The charging module 4 therefore has two outputs 21a, 21b for the transmission of electrical energy. The outputs 21a and 21b are associated with one each of the inputs 22 for electrical energy of the hearing devices 2a and 2b, so that energy is transmittable.

The outputs 21a and 21b for electrical energy are connected to a common energy management unit 83, which is in contact here with an input 26 for electrical energy of the charging module. The energy management unit 83 is additionally connected to an energy storage unit 27. The energy management unit 83 is coupled to the signal processing unit 84 and may be controlled thereby.

In the shown example, the charging module 4 has a microphone 29, which is likewise connected to the signal processing unit 84. Sound may be recorded by this microphone and forwarded to the hearing device 2a, 2b if the charging module 4 is masking the sound path to the hearing device.

All components and connections in FIG. 8 and FIG. 9 shown by dashed lines are optional components and connections. FIGS. 8 and 9 therefore each describe a plurality of expedient variants of the invention.

1. A method for charging an electrical device worn in an ear canal, the method comprising:
transmitting electrical energy from a charging module connected to the electrical device;
wherein the electrical device has at least one of: a rechargeable store for electrical energy or at least one accumulator, wherein the at least one of the rechargeable store for electrical energy or the accumulator of the electrical device is charged by transmission of electrical energy from the charging module to the electrical device, and wherein the electrical device is arranged in the ear of a person.

2. The method according to claim 1,
wherein the electrical device is a hearing device.

3. The method according to claim 1, wherein the electrical device is arranged in the ear canal such that a distal end of the electrical device is arranged proximally of a distal end of the ear canal.

4. The method according to claim 3, wherein the distal end of the electrical device is proximal of the distal end of the ear canal and a distance of the distal end of the electrical device from the distal end of the ear canal is greater than or equal to 2 mm.

5. The method according to claim 1, wherein the electrical energy is transmitted wirelessly from the charging module to the electrical device.

6. The method according to claim 1, wherein the electrical energy is transmitted at least one of: inductively, capacitively or optically from the charging module to the electrical device.

7. The method according to claim 1, wherein the electrical energy is transmitted from the charging module to the electrical device by at least one wire.

8. The method according to claim 1, wherein the electrical device remains in the ear canal for longer than a week, or wherein the electrical device is implanted.

9. The method according to claim 1, wherein an impedance of an input for the electrical energy of the electrical device is modulated based on information generated by the electrical device, and wherein the charging module detects the modulated impedance and reconstructs the information based on the detected modulated impedance.

10. An electrical device with at least one rechargeable store for electrical energy, comprising:
an input for electrical energy, via which the rechargeable store for electrical energy is chargeable, and wherein the electrical device is arrangeable in an ear canal of a person such that a distal end of the electrical device is arranged proximally of a distal end of the ear canal.

11. The electrical device according to claim 10, wherein the electrical device is a hearing device.

12. The electrical device according to claim 11, wherein the input for electrical energy is at least one of: a plug contact or an input for wireless energy transmission.

13. (canceled)

14. A charging module for charging an electrical device in an ear of a person, comprising:
an output for electrical energy; and
an input for electrical energy;
wherein the output for electrical energy is connectable to the input for electrical energy of the electrical device for transmitting electrical energy, wherein at least one charging module is at least one of: located at least partially in an ear canal or is shaped so that it may at least one of: rest on at least part of an auricle or surround the auricle.

15. The charging module according to claim 14, further comprising:
at least one of: a flexible structure or at least one curved band, at an end of which there is arranged at least part of the at least one charging module.

16. The charging module according to claim 14, having a curved ear clip, which is shaped so that it is arrangeable between the auricle and a head of the person, the clip partially running around the auricle.

17. The charging module according to claim 14, further comprising:
a support element which is shaped to at least one of: rest on the auricle or rest against a head and also surround the auricle.

18. The charging module according to claim 14, further comprising:
an ear unit, wherein the ear unit has an auricle part, which has a diameter greater than a diameter of the ear canal and smaller than a diameter of the auricle.

19. The charging module according to claim 18, wherein the ear unit includes an ear canal part, which has a diameter smaller than or equal to the diameter of the ear canal, wherein the output for electrical energy is arranged in the ear canal on the ear canal part.

20. The charging module according to claim 14, wherein the charging module has a store for electrical energy, from which electrical energy is capable of being conducted to the output for electrical energy.

21. The charging module according to claim 14, having an input for electrical energy, via which electrical energy is capable of being supplied to a store for electrical energy of the charging module and/or the output for electrical energy.

22. The charging module according to claim 21, wherein the input for electrical energy of the charging module is an input for at least one of: wireless energy transmission or wired energy transmission.

23. The charging module according to claim 14, further comprising:
a signal input for an information signal; and
a signal output for the information signal;
wherein the information signal received at the signal input is forwarded to the signal output, wherein the signal output is connectable to a signal input of an electrical device for signal transmission, and wherein the information signal is at least one of: an audio signal or a control signal.

24. The charging module according to claim 14, further comprising:
at least one microphone; and
a signal output;
wherein a signal received by the microphone is supplied to the signal output.

25. The charging module according to claim 14, further comprising:
at least one operating element, by means of which the electrical device may be operated.

26. (canceled)

27. A hearing system, comprising:
an electrical device with at least one rechargeable store for electrical energy, the electrical device including:
an input for electrical energy via which the rechargeable store for electrical energy is chargeable, and wherein the electrical device is arrangeable in an ear canal of a person such that a distal end of the electrical device is arranged proximally of a distal end of the ear canal;
a charging module, including:
a charging module output for electrical energy;
a charging module input for electrical energy;
wherein the charging module output for electrical energy is connectable to the input for electrical energy of the electrical device for transmitting electrical energy, and wherein the charging module is at least one of: located at least partially in the ear canal or is shaped to at least one of: rest on at least part of an auricle or surround the auricle.

28. The hearing system according to claim 27, wherein the hearing system has at least one of: two of the electrical devices or two parts of the charging module.

29. The hearing system according to claim 28, wherein the two parts of the charging module have a communications device for transmitting data between the parts.

30. The hearing system according to claim 29, wherein the communications device transmits the data at least one of: inductively or via radio waves.

31. The hearing system according to claim 29, wherein a setting of the at least one of: two parts of the charging module or the two electrical devices are synchronized via the communications device.

32. The hearing system according to claim 27, wherein the charging module further includes a transmitter for an information signal, and wherein the electrical device further includes a receiver for the information signal, wherein the charging module further includes a receiver for an information signal, and wherein the electrical device further includes a transmitter for the information signal.

33. The hearing system according to claim 32, wherein the information signal and the electrical energy are transmitted via same channel.

34. (canceled)

35. The method according to claim 1, wherein the electrical device is arranged in the ear canal such that a distal end of the electrical device is arranged at most 5 mm distally of a distal end of the ear canal.

36. The method according to claim 1, wherein the electrical device is arranged in the ear canal such that a distal end of the electrical device is arranged at most 2 mm distally of a distal end of the ear canal.

37. The method according to claim 3, wherein the distal end of the electrical device is proximal of the distal end of the ear canal and a distance of the distal end of the electrical device from the distal end of the ear canal is greater than or equal to 4 mm.

38. The method according to claim 3, wherein the distal end of the electrical device is proximal of the distal end of the ear canal and a distance of the distal end of the electrical device from the distal end of the ear canal is greater than or equal to 6 mm.

39. The electrical device according to claim 10, wherein the distal end of the electrical device is arranged at most 5 mm distally of a distal end of the ear canal.

40. The electrical device according to claim 10, wherein the distal end of the electrical device is arranged at most 2 mm distally of a distal end of the ear canal.
